(19) United States
(12) Patent Application Publication
(10) Pub. No.: US 2013/0212094 A1
(43) Pub. Date: Aug. 15, 2013

(54) VISUAL SIGNATURES FOR INDOOR POSITIONING

(71) Applicants: Ayman Fawzy NAGUIB, Cupertino, CA (US); Hui CHAO, San Jose, CA (US); Saumitra Mohan DAS, San Jose, CA (US); Rajarshi GUPTA, Sunnyvale, CA (US)

(72) Inventors: Ayman Fawzy NAGUIB, Cupertino, CA (US); Hui CHAO, San Jose, CA (US); Saumitra Mohan DAS, San Jose, CA (US); Rajarshi GUPTA, Sunnyvale, CA (US)

(73) Assignee: QUALCOMM INCORPORATED, San Diego, CA (US)

(21) Appl. No.: 13/531,311

(22) Filed: Jun. 22, 2012

Related U.S. Application Data
(60) Provisional application No. 61/525,704, filed on Aug. 19, 2011.

(51) Int. Cl. G06F 17/30

(52) U.S. Cl. CPC G06F 17/30528
USPC 707/730

(57) ABSTRACT

Systems and methods for managing and utilizing visual signature (VS) databases are described herein. A method for managing a VS database as described herein includes obtaining a plurality of images of objects represented by a VS; obtaining context information associated with the plurality of images; grouping the plurality of images into one or more context classifications according to the context information associated with the plurality of images; for respective ones of the one or more context classifications, selecting an image representative of the VS according to one or more criteria; and adding the selected images for the respective ones of the one or more context classifications to entries of the VS database corresponding to the VS.

### CROSS-REFERENCES TO RELATED APPLICATIONS

This application claims benefit of priority from U.S. Provisional Patent Application No. 61/525,704, filed Aug. 19, 2011, entitled “METHOD AND/OR APPARATUS FOR POSITION ESTIMATION.” Additionally, this application is related to co-pending U.S. patent application Ser. No. 13/486,359, filed Jun. 1, 2012, entitled “LOGO DETECTION FOR INDOOR POSITIONING.” Both of these applications are assigned to the assignee hereof and are incorporated in their entirety herein by reference.

### FIELD

The present disclosure relates to wireless communications, and more particularly to location based services for wireless communication devices.

### BACKGROUND

Advancements in wireless communication technology have greatly increased the versatility of today's wireless communication devices. These advancements have enabled wireless communication devices to evolve from simple mobile telephones and pagers into sophisticated computing devices capable of a wide variety of functionality such as multimedia recording and playback, event scheduling, word processing, e-commerce, etc. As a result, users of today's wireless communication devices are able to perform a wide range of tasks from a single, portable device that conventionally required either multiple devices or larger, non-portable equipment.

Various applications are utilized to obtain and utilized to locate the position of a wireless communication device. For instance, location based services (LBSs) leverage the location of an associated device to provide controls for one or more applications running on the device. Applications of LBS functionality implemented with respect to wireless communication devices include personal navigation, social networking, targeting of content (e.g., advertisements, search results, etc.), among others.

### SUMMARY

An example of a method for visual signature (VS) recognition at a mobile device is described herein. The method includes obtaining context information indicative of one or more context parameters of a camera; capturing a point of interest (POI) image within a field of view of the camera; submitting a query to a VS database for one or more candidate reference images associated with respective VSs of the VS database, the query providing as input the context information and the POI image; receiving information relating to the one or more candidate reference images in response to the query, wherein the one or more candidate reference images are associated with context parameters having at least a threshold amount of similarity with the one or more context parameters of the camera; and selecting one of the one or more candidate reference images and the VS associated therewith based on a comparison of the POI image and the one or more candidate reference images.

Implementations of the method may include one or more of the following features. The one or more context parameters include at least one of a time of detecting the POI, a date of detecting the POI, lighting conditions associated with the POI, a geographic area in which the camera is located, an identity of the camera, or settings utilized by the camera. The one or more context parameters are obtained from user input. The camera is associated with a wireless communication device, and the one or more context parameters are obtained from information stored on the wireless communication device. Selecting a candidate reference image from among the one or more candidate reference images that most closely matches the POI image. Assigning weights to respective ones of the one or more context parameters of the camera, identifying sets of reference images associated with respective VSs of the VS database and context parameters for the reference images of the sets of reference images, and, for each of the VSs, selecting an image from an associated one of the sets of reference images based on a comparison of the context parameters of the reference images and the context parameters of the camera, where the comparison is weighted according to the weights. Obtaining a location of the POI based on location data associated with a selected VS and estimating a location of the camera based at least in part on the location of the POI. The VS is associated with a retailer and the POI is a retail location operated by the retailer. Rebuilding the VS database based on a selected candidate reference image.

An example of a method for managing a VS database is described herein. The method includes obtaining images of objects represented by a VS; obtaining context information associated with the images; grouping the images into one or more context classifications according to the context information associated with the images; for respective context classifications, selecting an image representative of the VS according to one or more criteria; and adding selected images for the respective context classifications to entries of the VS database corresponding to the VS.

Implementations of the method may include one or more of the following features. The context information includes at least one of a time an image is captured, a date an image is captured, a location at which an image is captured, lighting conditions associated with an image, an identity of a camera with which an image is captured, or camera settings associated with an image. Modifying at least one of the images prior to the selecting via at least one of cropping or rotating. Extracting metadata embedded within respective ones of the images. Obtaining at least some of the images from an image sharing service or one or more mobile devices. Selecting an image according to image quality metrics. The image quality metrics include at least one of image resolution or observed level of background noise. For each of the context classifications, attempting to match images for the context classification with one or more other images for the context classification and selecting an image for the context classification that exhibits at least a threshold amount of similarity to a highest number of the one or more other images for the context classification.

Implementations of the method may additionally or alternatively include one or more of the following features. Receiving a query for images associated with the VS database, where the query is associated with a point of interest and one or more context parameters, and selecting candidate images from the VS database in response to the query. Evaluating estimated relevance of the candidate images according to the one or more context parameters, the point of interest and context parameters of the candidate images. Ranking the candidate images according to the estimated relevance. Performing a determination of whether a highest ranked candidate image matches the one or more context parameters and the point of interest with at least a threshold degree of confidence, selecting the highest ranked candidate image if the determination is positive, and repeating the determining for a next highest ranked candidate image if the determination is negative. Selecting one of the candidate images in response to the query and adjusting rankings of the candidate images based on the selecting. Assigning weights to respective context parameters associated with the query, identifying sets of images associated with respective VSs of the VS database and context parameters for the images of the sets of images, and, for each of the VSs, selecting an image from an associated one of the sets of images based on a comparison of the context parameters associated with the query and the context parameters for the images, where the comparison is weighted according to the weights.

An example of a VS recognition system is described herein. The system includes a camera associated with one or more context parameters and configured to provide imagery within a field of view of the camera; a POI detection module communicatively coupled to the camera and configured to detect a POI image within the field of view of the camera; a database query module communicatively coupled to the POI detection module and configured to submit a query to a VS database for one or more candidate reference images associated with respective VSs of the VS database, the query providing as input the one or more context parameters and the POI image; and a query processing module configured to receive information relating to the one or more candidate reference images in response to the query, where the one or more candidate reference images are associated with context parameters having at least a threshold amount of similarity with the one or more context parameters of the camera, and to select one of the one or more candidate reference images and the VS associated therewith based on a comparison of the POI image and the one or more candidate reference images.

Implementations of the system may include one or more of the following features. A context detection module communicatively coupled to the camera and the database query module and configured to obtain information relating to the one or more context parameters. The one or more context parameters include at least one of a time of detecting the POI, a date of detecting the POI, lighting conditions associated with the POI, a geographic area in which the camera is located, an identity of the camera, or settings utilized by the camera. The query processing module is further configured to select a candidate reference image from among the one or more candidate reference images that most closely matches the POI image. A positioning engine communicatively coupled to the query processing module and configured to obtain a location of the POI based on location data associated with a selected VS and to estimate a location of the camera based at least in part on the location of the POI. A wireless communications device in which the camera is housed. The VS database is stored by the wireless communications device. A database manager module communicatively coupled to the query processing module and the VS database and configured to dynamically configure and build the VS database based on a selected candidate reference image. The VS database is stored at a VS server remote from the wireless communications device.

An example of a VS database management system is described herein. The system includes an image analysis module configured to obtain images of objects represented by a VS and context information associated with the images, to group the images into one or more context classifications according to the context information associated with the images, and to select images for respective context classifications that best represent the VS according to one or more criteria; and a database population module communicatively coupled to the image analysis module and configured to add selected images for the respective context classifications to a VS database and to classify the selected images as entries of the VS database corresponding to the VS.

Implementations of the system may include one or more of the following features. The context information includes at least one of a time an image is captured, a date an image is captured, a location at which an image is captured, lighting conditions associated with an image, an identity of a camera with which an image is captured, or camera settings associated with an image. An image manager module communicatively coupled to the image analysis module and configured to modify at least one of the images prior to selection by the database population module. The image analysis module is further configured to obtain at least some of the images from an image sharing service or one or more mobile devices. The image analysis module is further configured to select an image for respective context classifications according to image quality metrics. The image analysis module is further configured to select an image for respective context classifications by attempting to match images for a context classification with one or more other images for the context classification and selecting an image for the context classification that exhibits at least a threshold amount of similarity to a highest number of the one or more other images for the context classification.

Implementations of the system may additionally or alternatively include one or more of the following features. The image analysis module is further configured to receive a query for images associated with the VS database, where the query is associated with a point of interest and one or more context parameters, and to select candidate images from the VS database in response to the query. The image analysis module is further configured to evaluate estimated relevance of the candidate images according to the context parameters, the point of interest and context parameters of the candidate images and to rank the candidate images according to the estimated relevance. The image analysis module is further configured to determine whether a highest ranked candidate image matches the context parameters and the point of interest with at least a threshold degree of confidence, to select the highest ranked candidate image upon a positive determination, and to repeat the determining for a next highest ranked candidate image upon a negative determination. The image analysis module is further configured to select one of the candidate images in response to the query and to adjust rankings of the candidate images based on the selecting. The image analysis module is further configured to assign weights to respective context parameters associated with the query, to identify sets of images associated with respective VSs of the VS database and context parameters for the images of the sets of images, and to select an image for each of the VSs from an associated one of the sets of images based on a comparison of the context parameters associated with the query and the context parameters for the images, where the comparison is weighted according to the weights.

An example of a system for VS recognition is described herein. The system includes a camera associated with one or more context parameters and configured to provide imagery within a field of view of the camera; POI detection means, communicatively coupled to the camera, for detecting a POI image within the field of view of the camera; query means, commutatively coupled to the POI detection means, for submitting a query to a VS database for one or more candidate reference images associated with respective VSs of the VS database, the query providing as input the one or more context parameters and the POI image; and selection means, communicatively coupled to the query means, for receiving information relating to the candidate reference images in response to the query, where the candidate reference images are associated with context parameters having at least a threshold amount of overlap with the one or more context parameters of the camera, and selecting one of the candidate reference images and the VS associated therewith based on a comparison of the POI image and the one or more candidate reference images.

Implementations of the system may include one or more of the following features. Context means, communicatively coupled to the camera and the query means, for obtaining information relating to the context parameters. The context parameters include at least one of a time of detecting the POI, a date of detecting the POI, lighting conditions associated with the POI, a geographic area in which the camera is located, an identity of the camera, or settings utilized by the camera. The selection means includes means for selecting a candidate reference image from among the candidate reference images that most closely matches the POI image. Positioning means, communicatively coupled to the selection means, for obtaining a location of the POI based on location data associated with a selected VS and estimating a location of the camera based at least in part on the location of the POI. Database manager means, communicatively coupled to the selection means and the VS database, for dynamically configuring and building the VS database based on a selected candidate reference image.

A system for VS database management is described herein. The system includes collection means for obtaining images of objects represented by a VS and context information associated with the images; classification means, communicatively coupled to the collection means, for grouping the images into one or more context classifications according to the context information associated with the images; selection means, communicatively coupled to the collection means and the classification means, for selecting images for respective context classifications that best represent the VS according to one or more criteria; and database population means, communicatively coupled to the selection means, for storing images selected by the selection means for the respective context classifications as entries of a VS database corresponding to the VS.

Implementations of the system may include one or more of the following features. The context information includes at least one of a time an image is captured, a date an image is captured, a location at which an image is captured, lighting conditions associated with an image, an identity of a camera with which an image is captured, or camera settings associated with an image. Image management means, communicatively coupled to the collection means, for modifying at least one of the images obtained by the collection means. The collection means includes means for obtaining at least some of the images from an image sharing service or one or more mobile devices. The selection means includes means for selecting an image for respective context classifications according to image quality metrics. The selection means includes means for attempting to match images for a context classification with one or more other images for the context classification and means for selecting an image for the context classification that exhibits at least a threshold amount of similarity to a highest number of the one or more other images for the context classification.

Implementations of the system may additionally or alternatively include one or more of the following features. Query processing means, communicatively coupled to the database population means, for receiving a query for images associated with the VS database, where the query is associated with a point of interest and one or more context parameters, and selecting candidate images from the VS database in response to the query. The query processing means includes means for evaluating estimated relevance of the candidate images according to the context parameters, the point of interest and context parameters of the candidate images, and means for ranking the candidate images according to the estimated relevance. The query processing means includes means for determining whether a highest ranked candidate image matches the context parameters and the point of interest with at least a threshold degree of confidence, means for selecting the highest ranked candidate image upon a positive determination, and means for repeating the determining for a next highest ranked candidate image upon a negative determination. The query processing means includes means for selecting one of the candidate images in response to the query and means for adjusting rankings of the candidate images based on the selecting. The query processing means includes means for assigning weights to respective context parameters associated with the query, means for identifying sets of images associated with respective VSs of the VS database and context parameters for the images of the sets of images, and means for selecting an image for each of the VSs from an associated one of the sets of images based on a comparison of the context parameters associated with the query and the context parameters for the images, where the comparison is weighted according to the weights.

An example of a computer program product described herein resides on a processor-executable computer storage medium and includes processor-executable instructions configured to cause a processor to identify context information indicative of one or more context parameters of a camera; capture POI image features within a field of view of the camera; submit a query to a VS database for one or more candidate reference images associated with respective VSs of the VS database, the query providing as input the context information and the POI image features; receive information relating to the candidate reference images in response to the query, where the candidate reference images are associated with context parameters having at least a threshold amount of overlap with the one or more context parameters of the camera; and select one of the candidate reference images and the VS associated therewith based on a comparison of the POI image features and the one or more candidate reference images.

Implementations of the computer program product may include one or more of the following features. Instructions configured to cause the processor to obtain information relating to the context parameters. The context parameters include at least one of a time of detecting the POI, a date of detecting the POI, lighting conditions associated with the POI, a geographic area in which the camera is located, an identity of the camera, or settings utilized by the camera. Instructions configured to cause the processor to select a candidate reference image that most closely matches the POI image features. Instructions configured to cause the processor to obtain a location of the POI based on location data associated with a selected VS and to estimate a location of the camera based at least in part on the location of the POI. Instructions configured to cause the processor to rebuild the VS database based on a selected candidate reference image.

An example of a computer program product described herein resides on a processor-executable computer storage medium and includes processor-executable instructions configured to cause a processor to obtain images of objects represented by a VS and context information associated with the images; group the images into one or more context classifications according to the context information associated with the images; select images for respective context classifications that best represent the VS according to one or more criteria; and store images selected for the respective context classifications as entries of a VS database corresponding to the VS.

Implementations of the computer program product may include one or more of the following features. The context information includes at least one of a time an image is captured, a date an image is captured, a location at which an image is captured, lighting conditions associated with an image, an identity of a camera with which an image is captured, or camera settings associated with an image. Instructions configured to cause the processor to modify at least one of the obtained images. Instructions configured to cause the processor to obtain at least some of the images from an image sharing service or one or more mobile devices. Instructions configured to cause the processor to select an image for respective context classifications according to image quality metrics. Instructions configured to cause the processor to attempt to match images for a context classification with one or more other images for the context classification and to select an image for the context classification that exhibits at least a threshold amount of similarity to a highest number of the one or more other images for the context classification.

Implementations of the computer program product may additionally or alternatively include one or more of the following features. Instructions configured to cause the processor to receive a query for images associated with the VS database, where the query is associated with a point of interest and one or more context parameters, and to select candidate images from the VS database in response to the query. Instructions configured to cause the processor to evaluate estimated relevance of the candidate images according to the one or more context parameters, the point of interest and context parameters of the candidate images, and to rank the plurality of candidate images according to the estimated relevance. Instructions configured to cause the processor to determine whether a highest ranked candidate image matches the one or more context parameters and the point of interest with at least a threshold degree of confidence, to select the highest ranked candidate image upon a positive determination, and to repeat the determining for a next highest ranked candidate image upon a negative determination. Instructions configured to cause the processor to select one of the candidate images in response to the query and to adjust rankings of the candidate images based on the selecting. Instructions configured to cause the processor to assign weights to respective context parameters associated with the query, to identify sets of images associated with respective VSs of the VS database and context parameters for the images of the sets of images, and to select, for each of the VSs, an image from an associated one of the sets of images based on a comparison of the context parameters associated with the query and the context parameters for the images, where the comparison is weighted according to the weights.

Items and/or techniques described herein may provide one or more of the following capabilities, as well as other capabilities not mentioned. Multiple points of interest can be detected from a common representative visual signature, reducing the size and complexity of an associated reference database. Robustness of a visual signature database can be improved by representing a visual signature within the database in a variety of different contexts that affect the appearance of the visual signature. Similarly, accuracy and adaptability of queries to a visual signature database can be improved by including relevant context parameters within the query. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a schematic diagram of a wireless telecommunication system.

FIG. 2 is a block diagram of components of one embodiment of a mobile station shown in FIG. 1.

FIG. 3 is a block diagram of a system for building a crowdsourced visual signature database.

FIG. 4 is a block diagram of a system for performing context-aware queries to a visual signature database.

FIG. 5 is a diagram of an example of an interaction between the mobile station shown in FIG. 1 and a point of interest.

FIG. 6 is a block diagram of an indoor positioning system that utilizes a brand specific visual signature database.

FIG. 7 is a block flow diagram of a process of visual signature recognition.

FIG. 8 is a block flow diagram of a process of populating a visual signature database.

FIG. 9 is a block diagram of an example of a client computer system.

FIG. 10 is a block diagram of an example of a server computer system.

### DETAILED DESCRIPTION

Described herein are techniques for building and utilizing robust visual signature (VS) databases for vision-based positioning. A VS database is populated with entries corresponding to various VSs in different contexts, which are determined according to different context parameters such as time of day, season, lighting conditions, camera parameters (resolution, zoom level, etc.) and/or other factors. When the VS database is subsequently queried, context parameters associated with the query are leveraged to obtain a resulting entry from the VS database that substantially matches the context parameters. By performing context-aware database population and querying as described herein, the performance of vision-based positioning techniques can be improved.

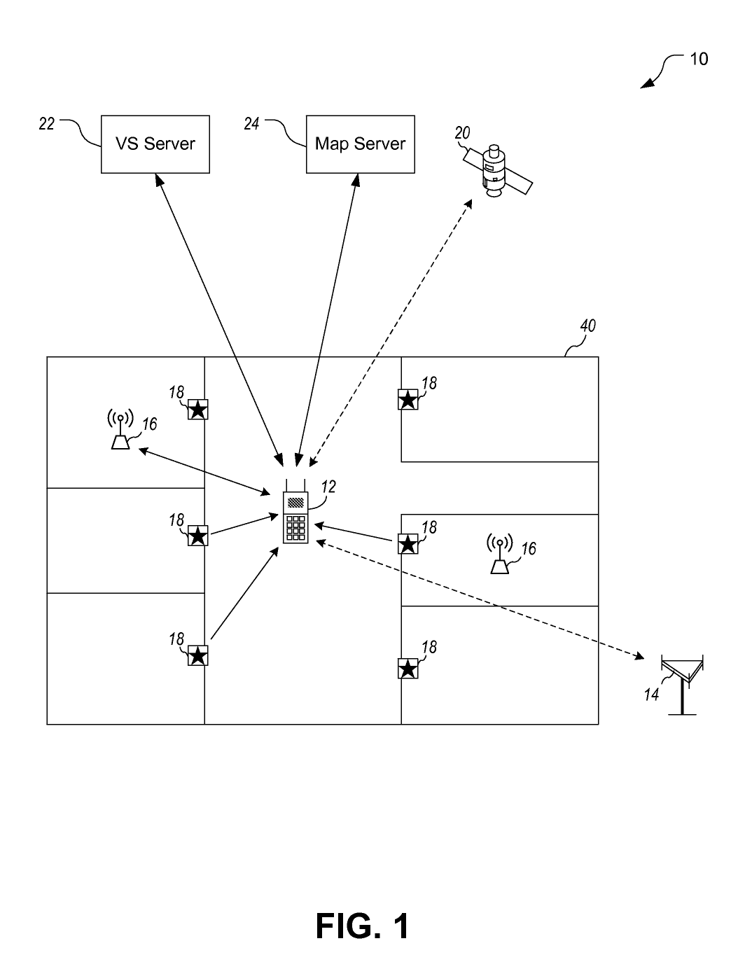

Systems and methods described herein operate via one or more mobile devices operating in a wireless communication system. Referring to FIG. 1, a wireless communication system 10 includes one or more base transceiver stations (BTSs), here one BTS 14, and wireless access points (APs) 16. The BTS 14 and APs 16 provide communication service for a variety of wireless communication devices, referred to herein as mobile devices 12. Wireless communication devices served by a BTS 14 and/or AP 16 can include, but are not limited to, personal digital assistants (PDAs), smartphones, computing devices such as laptops, desktops or tablet computers, automobile computing systems, etc., whether presently existing or developed in the future.

The system 10 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The BTS 14 and APs 16 can wirelessly communicate with the mobile devices 12 in the system 10 via antennas. A BTS 14 may also be referred to as a base station, a Node B, an evolved Node B (eNB), etc. The APs 16 may also be referred to as access nodes (ANs), hotspots, etc. The BTS 14 is configured to communicate with mobile devices 12 via multiple carriers. The BTS 14 can provide communication coverage for a respective geographic area, such as a cell. The cell of the BTS 14 can be partitioned into multiple sectors as a function of the base station antennas.

The system 10 may include only macro base stations 14 or it can have base stations 14 of different types, e.g., macro, pico, and/or femto base stations, etc. A macro base station may cover a relatively large geographic area (e.g., several kilometers in radius) and may allow unrestricted access by terminals with service subscription. A pico base station may cover a relatively small geographic area (e.g., a pico cell) and may allow unrestricted access by terminals with service subscription. A femto or home base station may cover a relatively small geographic area (e.g., a femto cell) and may allow restricted access by terminals having association with the femto cell (e.g., terminals for users in a home).

As further shown in system 10, the mobile device 12 is positioned within a venue 40 such as a shopping mall, a school, or other indoor or outdoor area. The APs 16 are positioned within the venue 40 and provide communication coverage for respective areas (rooms, stores, etc.) of the venue 40. Access to an AP 16 in the system 10 can be open, or alternatively access can be secured with a password, encryption key or other credentials.

The mobile devices 12 can be dispersed throughout the system 10. The mobile devices 12 may be referred to as terminals, access terminals (ATs), mobile stations, user equipment (UE), subscriber units, etc. The mobile devices 12 can include various devices as listed above and/or any other devices.

As further shown in FIG. 1, a mobile device 12 may receive navigation signals from a satellite positioning system (SPS), e.g., through SPS satellites 20. The SPS satellites 20 can be associated with a single multiple global navigation satellite system (GNSS) or multiple such systems. A GNSS associated with satellites 20 can include, but are not limited to, Global Positioning System (GPS), Galileo, Glonass, Beidou (Compass), etc. SPS satellites 20 are also referred to as satellites, space vehicles (SVs), etc.

A mobile device 12 within the system 10 can estimate its current position within the system 10 using various techniques, based on other communication entities within view and/or information available to the mobile device 12. For instance, a mobile device 12 can estimate its position using information obtained from APs 16 associated with one or more wireless local area networks (LANs), personal area networks (PANs) utilizing a networking technology such as Bluetooth or ZigBee, etc., SPS satellites 20, and/or map constraint data obtained from a map server 24 or location context identifier (LCI) server, as well as additional information as described in further detail below.

As a further example, the mobile device 12 can visually estimate its position relative to the known positions of various landmarks 18, such as storefront logos or other markers, positioned within the venue 40. As shown by system 10, the mobile device 12 captures images (via a camera) of various landmarks 18 within view of the mobile device 12. The mobile device 12 communicates with a VS server 22 to identify the landmarks 18 and determine their locations. For a given indoor area identified by an LCI, the mobile device 12 may also determine the locations of the landmarks 18 based on a map of the LCI. The map, or portions thereof, can be stored in advance by the mobile device 12 and/or obtained on demand from a map server 24 or another entity within the system 10. Based on the locations of the landmarks 18, as well as other information obtained from the BTS 14, APs 16, or the mobile device 12 itself, the mobile device 12 estimates its position within the venue 40. The interaction between the mobile device 12 and the VS server 22, as well as positioning based on this interaction, are described in further detail below.

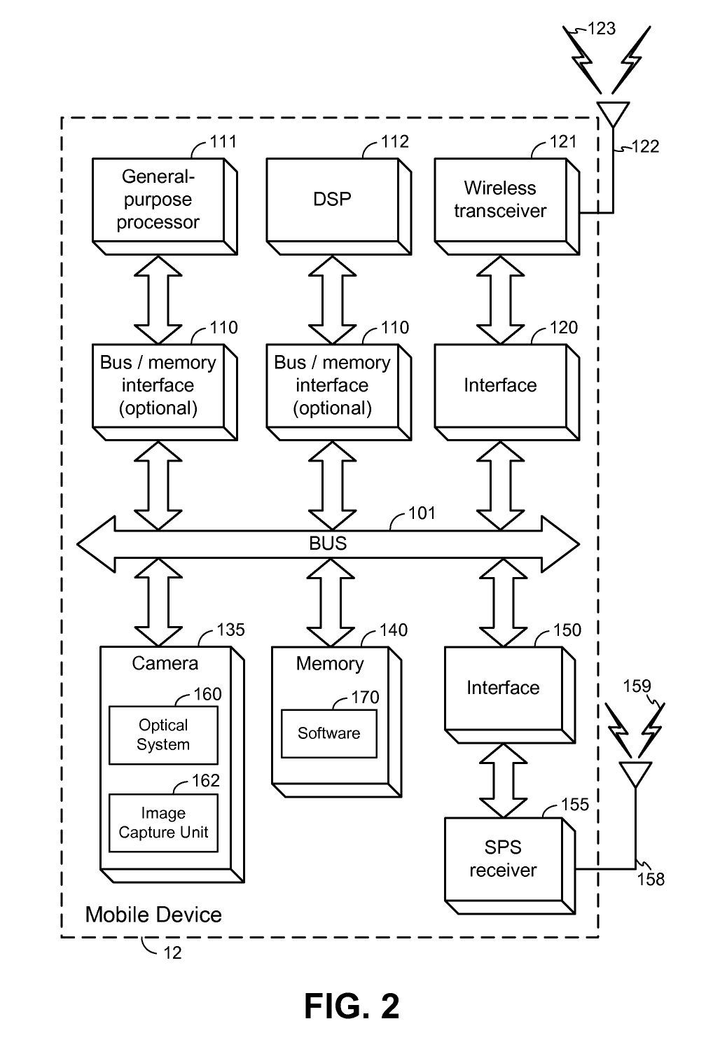

Referring next to FIG. 2, an example one of the mobile devices 12 includes a wireless transceiver 121 that sends and receives wireless signals 123 via a wireless antenna 122 over a wireless network. The wireless transceiver 121 is connected to a bus 101 by a wireless transceiver bus interface 120. While shown as distinct components in FIG. 2, the wireless transceiver bus interface 120 may also be a part of the wireless transceiver 121. Here, the mobile device 12 is illustrated as having a single wireless transceiver 121. However, a mobile device 12 can alternatively have multiple wireless transceivers 121 and wireless antennas 122 to support multiple communication standards such as WiFi, CDMA, Wideband CDMA (WCDMA), Long Term Evolution (LTE), Bluetooth, etc.

The mobile device 12 also includes an SPS receiver 155 that receives SPS signals 159 (e.g., from SPS satellites 20) via an SPS antenna 158. The SPS receiver 155 processes, in whole or in part, the SPS signals 159 and uses these SPS signals 159 to determine the location of the mobile device 12. A general-purpose processor 111, memory 140, DSP 112 and/or specialized processor(s) (not shown) may also be utilized to process the SPS signals 159, in whole or in part, and/or to calculate the location of the mobile device 12, in conjunction with SPS receiver 155. Storage of information from the SPS signals 159 or other location signals is performed using a memory 140 or registers (not shown). While only one general purpose processor 111, one DSP 112 and one memory 140 are shown in FIG. 2, more than one of any, a pair, or all of these components could be used by the mobile device 12.

The general purpose processor 111 and DSP 112 associated with the mobile device 12 are connected to the bus 101, either directly or by a bus interface 110. Additionally, the memory 140 associated with the mobile device 12 is connected to the bus 101 either directly or by a bus interface (not shown). The bus interfaces 110, when implemented, can be integrated with or independent of the general-purpose processor 111, DSP 112 and/or memory 140 with which they are associated.

The memory 140 can include a non-transitory computer-readable storage medium (or media) that stores functions as one or more instructions or code. Media that can make up the memory 140 include, but are not limited to, RAM, ROM, FLASH, disc drives, etc. Functions stored by the memory 140 are executed by general-purpose processor(s) 111, specialized processors, or DSP(s) 112. Thus, the memory 140 is a processor-readable memory and/or a computer-readable memory that stores software 170 (programming code, instructions, etc.) configured to cause the processor(s) 111 and/or DSP(s) 112 to perform the functions described. Alternatively, one or more functions of the mobile device 12 may be performed in whole or in part in hardware.

The mobile device 12 further includes a camera 135 that captures images and/or video in the vicinity of the mobile device 12. The camera 135 includes an optical system 160 including one or more lenses, which collectively define a field of view of the camera 135 from which images are captured. Lenses and/or other components of the optical system 160 can be housed within the mobile device 12 and/or external to the mobile device 12, e.g., as lens attachments or the like. The optical system 160 is communicatively coupled with an image capture unit 162. The image capture unit 162 includes a charge-coupled device (CCD) and/or other technology to convert optical images into electrical information that is transferred to one or more processing entities of the mobile device 12, such as the general-purpose processor 111 and/or the DSP 112.

While the mobile device 12 here includes one camera 135, multiple cameras 135 could be used, such as a front-facing camera disposed along a front side of the mobile device 12 and a back-facing camera disposed along a back side of the mobile device 12, which can operate interdependently or independently of one another. The camera 135 is connected to the bus 101, either independently or through a bus interface 110. For instance, the camera 135 can communicate with the DSP 112 through the bus 101 in order to process images captured by the image capture unit 162 in the event that the camera 135 does not have an independent image processor. In addition, the camera 135 may be associated with other components not shown in FIG. 2, such as a microphone for capturing audio associated with a given captured video segment, sensors configured to detect the directionality or attitude of the image, etc. The camera 135 can additionally communicate with the general-purpose processor(s) 111 and/or memory 140 to generate or otherwise obtain metadata associated with captured images or video. Metadata associated with, or linked to, an image contains information regarding various characteristics of the image. For instance, metadata includes a time, date and/or location at which an image is captured, image dimensions or resolution, an identity of the camera 135 and/or mobile device 12 used to capture the image, etc. Metadata utilized by the cameras 135 are generated and/or stored in a suitable format, such as exchangeable image file format (EXIF) tags or the like. The camera 135 can also communicate with the wireless transceiver 121 to facilitate transmission of images or video captured by the camera 135 to one or more other entities within an associated communication network.

Vision-based positioning enables a device to estimate its location based on visible landmarks, or points of interest (POIs), located near the device. In order to provide visual cues to locate POIs, databases and/or other reference sources are used. For instance, a VS database includes information relating to VSs that are representative of various POIs in a given environment (e.g., a shopping mall, etc.). A device then estimates its location using vision-based positioning by capturing one or more images of an area surrounding the device (e.g., using a camera 135), identifying POI(s) in the captured image(s) using a VS database and/or other reference information, and obtaining a position estimate from collected information relating to the identified POI(s). Techniques by which a device performs vision-based positioning are described in further detail below.

A VS, such as that contained within a VS database, leverages similarities between similar entities in order to provide a generalized representation of those entities. For instance, as stores of the same brand often utilize the same or similar logos or storefront appearance for purposes of consistent branding, stores of a common brand can be represented using a common VS that includes the store logo, storefront appearance, etc. By utilizing VSs to exploit commonalities between similar locations, such as stores of the same brand, the size of a VS database can be reduced as compared to that of a similar database that contains information corresponding to only individual POIs. For instance, a small set of logos or storefront images could be used as visual cues to provide positioning solution in a large number of venues without having to visit each venue to take photos.

Various information associated with a VS, such as a storefront appearance or store logo information, can be made available by a third party such as a venue associated with the VS (e.g., a store having logos or other visual branding representative of the VS, etc.). For instance, as noted above, a VS corresponding to a store can include a logo associated with the store. However, a device may encounter reduced accuracy in matching captured images to a given VS under certain circumstances. In the case of a VS containing information relating to a logo, the appearance of a logo located at a given store may change due to time of day (e.g., night vs. day, lighting/shadowing based on time of day and day of the year), season (e.g., a storefront may be modified for holidays such as Christmas), lighting conditions (e.g., a logo may be front-lit or back-lit, etc.), or other factors. These differences can cause elements of a storefront at a given location to have varying edge features, which can result in difficulty and reduced accuracy in matching the storefront to a reference VS.

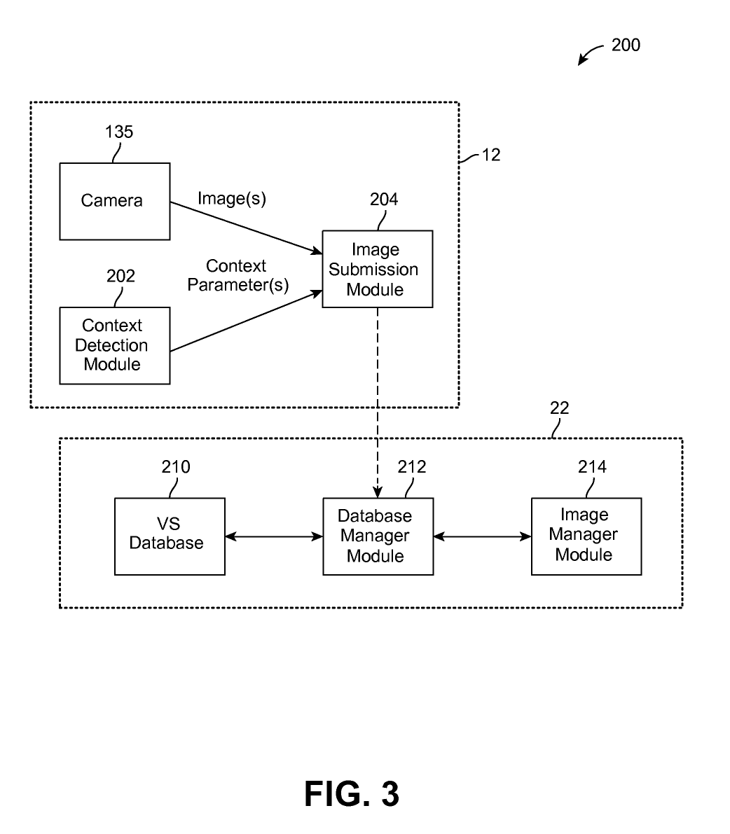

To increase the accuracy of VS matching and to increase the robustness of a VS database, systems and methods herein are used to capture different appearances and metadata of a given VS by crowdsourcing images of storefront logos and other visual elements corresponding to the VS. Subsequently, during positioning, relevant (preferably the most relevant) reference images for a given VS are chosen as visual cues for a device and/or user to match based on context parameters such as time, date, lighting conditions, etc. FIG. 3 illustrates a system 200 for collecting crowdsourced reference images corresponding to a VS of a retailer or other entity as well as metadata associated with the reference images. The camera 135 is positioned within or otherwise associated with a mobile device 12 as described above and captures one or more images corresponding to a storefront, logo or other object to be represented by a VS.

A context detection module 202 identifies one or more context parameters relating to the camera 135 and/or the captured image(s). Here, the context detection module 202 is implemented at the mobile device 12 as a software component, e.g., by the general purpose processor 111 executing software code comprising processor-readable instructions stored on the memory 140. Alternatively, the context detection module 202 could be implemented in hardware or a combination of hardware and software. The context parameters can take any format that is readable and interpretable by the general purpose processor 111, such as image metadata and/or other information types. Metadata for the context of a given image includes the time and/or date the image was captured, lighting conditions, etc. The metadata and/or context parameters can also include camera information, camera setting information, or the like. These parameters can be represented as a vector (e.g., time, date, season, lighting or weather conditions, etc.), a context feature, etc. The context detection module 202 can be implemented by the camera 135 and/or one or more entities separate from the camera 135, e.g., by the general purpose processor 111, the DSP 112, or the like.

The context detection module 202 can obtain context parameters from the camera 135 itself and/or other components of the mobile device 12, such as the memory 140. By way of example, the context detection module can obtain lighting information from the optical system 160 of the camera 135, information relating to time, date or season from a hardware or software clock implemented by the mobile device 12, rough location estimate information from the wireless transceiver 121 and/or SPS receiver 155, weather information from a network source (such as a weather web site or the like) via the wireless transceiver 121, etc. Other types of context information and/or sources for such information could also be used.

Captured images and their associated context parameters are collected by an image submission module 204 and communicated from the image submission module 204 to a network-based database manager module 212 implemented here by the VS server 22. Here, the image submission module 204 is implemented by the mobile device 12 (e.g., via the wireless transceiver 121 and associated wireless transceiver bus interface 120, etc.). Alternatively, the image submission module 204 can be implemented by a device distinct from and remote to the device that includes the camera 135. For instance, the camera 135 and context detection module 202 can obtain images and associated context data and subsequently transfer, e.g., wirelessly transfer, this information to a separate computing device, a network-based image sharing service, or the like, which implements the image submission module 204.

Submission of information from the image submission module 204 can be made dependent upon user consent or authorization. For instance, an image capture application associated with the camera 135 and/or the context detection module 202 and/or a third-party image hosting or sharing service can condition use of the application and/or service (e.g., through a terms of use agreement or the like) upon authorization of the image submission module 204 to convey information to the database manager module 212. Alternatively, a user of the camera 135 and/or context detection module 202 can be given an option to separately authorize use of the application and/or service. User consent or authorization may also be given in a limited manner, e.g., to only pre-designated images or metadata or categories of images or metadata. A user can also be given an option to add, remove and/or modify metadata or other context parameters associated with an image prior to submission by the image submission module 204.

Submission of information via the image submission module 204 can occur automatically, e.g., as part of a vision-based positioning procedure. For example, as a user pans the camera 135 to calculate position, images can be captured by the camera 135 and provided to the image submission module 204. As another example, the context detection module 202 can automatically tag images captured by the camera 135 with metadata (e.g., EXIF tag data, etc.), which can be submitted along with the corresponding images to the image submission module 204.

The database manager module 212 obtains images and related context parameters. The database manager module 212 includes an image analysis module 126 and a database population module 218 to analyze the received images and context parameters and selectively populate an associated VS database 210 with the received images. Information can be received by the database manager module 212 from one or more image submission modules 204 as described above, or alternatively the database manager module 212 may obtain information from other sources. For instance, a venue owner can submit images of a venue along with corresponding context parameters. This submission can be a direct submission to the database manager module 212 or an indirect submission. For example, a venue owner may submit images of the venue to one or more third party entities such as a business directory, an advertising service, etc., and these third party entities can in turn provide the images to the database manager module 212.

Once images are submitted to the database manager module 212, they are checked and qualified by the image analysis module 216. To reduce the size of the VS database 210, images can be tested for quality before they are added to the database as reference images for a given VS. The image analysis module 216 can conduct quality testing for candidate reference images in various ways. For instance, the image analysis module 216 can select a reference image on the basis of one or more quality metrics (e.g., defined in terms of resolution, background noise, etc.). Alternatively, a set of candidate reference images can be tested in turn by attempting to match a given candidate reference image in the set with the other images in the set, such that a candidate reference image that matches the most other images is deemed the most representative image of the set and added to the VS database 210 by the database population module 218. Other techniques for selecting an image from among multiple candidate images obtained via crowdsourcing or other means are also possible.

As additionally shown in FIG. 3, an image manager module 214 can be used to perform one or more operations on reference images prior to and/or after selection for the VS database 210. These operations can include cropping, rotating, color level or contrast adjusting, and/or any other suitable operations to change the images as desired, e.g., to improve the quality or change the orientation of the images. The image manager module 214 may also implement further image manipulation and/or enhancement functions as generally known in the art to enhance the quality of a given reference image, or alternatively the image manager module 214 may connect to one or more remote processing facilities that implement these functions. The image manager module 214 can also be utilized in combination with the database manager module 212 to operate upon an image in order to determine whether an image is a valid reference image for a given VS. For instance, the image manager module 214 can crop, rotate, or otherwise modify an image in order to determine whether it contains objects representative of one or more VSs. If such objects are detected, the image can be considered as a candidate reference image for the corresponding VSs.

From collected context parameters and/or images, the database population module 218 identifies various contexts that affect the appearance of a VS. Context groupings are defined for respective VSs in the VS database 210. These context groupings or sets each include one or more context parameters that affect the appearance of an object associated with the VS in a similar manner. For instance, a first context grouping can correspond to normal ambient lighting, a second context grouping can correspond to darkened ambient lighting (e.g., due to night, cloud cover, etc.) and a front-oriented lighting source, a third context grouping can correspond to darkened ambient lighting and a rear-oriented lighting source, etc. Context groupings can also be associated with other contexts such as dates and/or seasons, camera angles, geographical regions (e.g., cities, states, countries, or larger regions such as North America, Europe, East Asia, etc.), etc. Context groupings can also correspond to different versions of the same object; for instance, a retailer may have multiple versions of the same logo, each of which can correspond to different context groupings. In the event that the VS database 210 is populated with reference images captured by cameras 135, the VS database 210 may also include context groupings relating to camera type (e.g., integrated smartphone camera, point and shoot, single-lens reflex (SLR), etc.), camera brand and/or model, or camera settings (e.g., shutter speed, flash settings, exposure time, image filters employed, zoom level, etc.). Here, each context grouping in the VS database 210 is associated with a VS entry that includes a reference image representative of objects corresponding to the VS and the corresponding context(s). Alternatively, one VS entry could be associated with multiple context groupings, or vice versa.

Preferably, the VS database 210 contains reference images for respective VSs that are representative of a wide range of contexts. If the range of potential contextual information is regarded as a multi-dimensional feature space, this space is preferably evenly sampled by reference images in the VS database 210. For instance, in an example with location or region, season and camera model as primary contextual features, for each region (e.g., Americas, Asia, Europe, etc., or regions with finer granularity), at each season, and with each major camera model, a representative reference image is desirably included in the VS database 210. By providing an even sampling of contexts in this manner, the VS database 210 includes a representative reference image for various contexts.

As new images are collected for a given point of interest and context, various techniques can be performed as described above in order to determine whether to add the images to the VS database 210. If the images are to be added, older images corresponding to the same point of interest and context can be kept or discarded. For example, an instance of the VS database 210 can be configured to retain only one copy of a reference image for a given VS and context. Alternatively, the VS database 210 can be configured to retain all images added to the database. In such a case, the date and/or time at which the image was added to the VS database 210 can be recorded and used to index the images within the VS database 210, and/or for other uses. Other alternatives could utilize an image retention policy having a scope between those of the former two examples; for instance, images added to the VS database 210 for a given VS and context may be indexed by the date/time they were added to the VS database and retained until either expiration of a predetermined time period or storage of a threshold number of images for the same VS and context.

As an alternative to maintaining a static VS database 210, the database manager module 212 can dynamically configure and build a VS database 210, or different versions of a VS database 210, by selecting different candidate reference images in real time or semi-real time (e.g., based on changes in season or weather, etc.). The database manager module 212 may also build the VS database 210 offline with multiple versions that can be made available for different lighting conditions, different smartphone brands or camera types/qualities, or other context parameters.

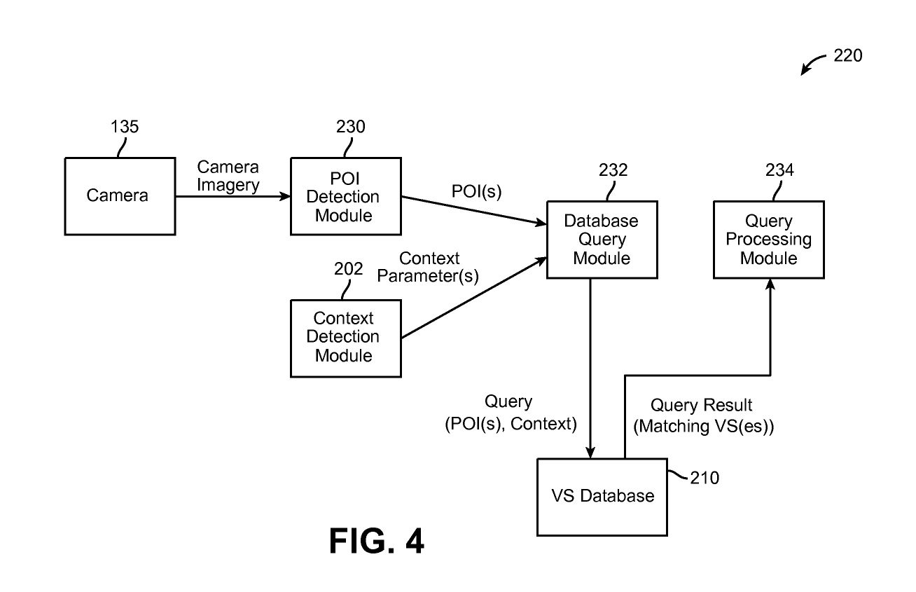

Based on a constructed VS database 210, a system 220 for employing the VS database 210 to perform VS recognition is illustrated by FIG. 4. Here, the system shown by FIG. 4 is used as part of a vision-based navigation application, such as an indoor navigation application. The system 220 could, alternatively, be utilized in combination with any other application or as a stand-alone system. While FIG. 3 and the above description relates to a VS database 210 constructed at a network-based VS server 22 via a crowdsourcing process, the VS database as implemented here in FIG. 4 need not be network-based and may instead be at least partially locally stored on and implemented by a mobile device 12. For instance, prior to performing the operations discussed below with respect to FIG. 4, a mobile device 12 can identify a venue 40 in which the mobile device 12 is or will be generally located and obtain a VS database 210 corresponding to landmarks (e.g., stores, etc.) within the venue 40. In such a case, the operations described below could then be performed solely by the mobile device 12. The fundamentals of the operations described below would not vary between a local VS database 210 and a centralized VS database 210 stored on a VS server 22, and the following description is intended to be directed to both of these cases with the exception of portions that explicitly state otherwise.

During operation of the system 220, imagery captured by the camera 135 is passed to a POI detection module 230 that detects one or more POIs in view of the camera 135. The imagery provided by the camera 135 to the POI detection module 230 may be continuous, real-time imagery, or alternatively the camera 135 may be configured to capture images according to a predetermined schedule (e.g., defined by a sample rate) and provide some or all of these images to the POI detection module 230. A user of the camera 135 need not actuate the camera 135 to capture images during the POI detection process. Instead, the POI detection module 230 can be configured to detect objects within view of the camera 135 as the user pans or otherwise moves the camera 135. In addition to the POIs detected by the POI detection module 230, the context detection module 202 collects context parameters as described above.

A database query module 232 submits a query for each detected POI to the database manager module 212 for reference images having a similar context (e.g., time, date, lighting conditions, etc.) as the currently identified context of the camera 135. Here, the database manager module 212 is associated with an entity at which the VS database 210 resides, e.g., the mobile device 12 for a local database and/or a VS server 22 for a central database. In response to this query, the database manager module 212 returns a predetermined number of candidate reference images from the VS database 210 having a similar context to that of the camera 135 to a query processing module 234. Each of the reference images corresponds to, and is representative of, a candidate VS of a POI stored by the VS database 210. Based on a set of candidate reference images retrieved from the VS database 210 in response to a query, a best candidate image can be chosen by a network service associated with the VS database 210, a device associated with the camera 135, or another entity based on various image feature matching techniques generally known in the art. In the case of a vision-based positioning application, this selected image is matched to a location associated with the candidate VS represented by the selected image, which is in turn utilized to locate the device associated with the camera 135.

As discussed above, upon receiving a request for image features for a particular POI, features from a predetermined number N of images in the VS database 210 having context features closest to the current context of the camera 135 are sent to the query processing module 234 of the requesting mobile device 12. When operating the system 220 shown in FIG. 4, the most relevant images for each detected POI, as determined based on image metadata, are loaded from the VS database 210 to the requesting device as primary visual cues. Relevance is determined using a weight assignment to various metadata for each image in the VS database when the metadata indicate a system and/or state that are similar to the current system and/or state of the user. These metadata can include images taken at a similar time (e.g., day, night, evening, etc.), images taken with a similar camera and/or similar camera settings (e.g., flash enabled or disabled, zoom level, exposure, etc.), images taken in a similar geographic region, and so on. Metadata relating to a camera and/or camera settings can be obtained from EXIF data or other data sources.

A determination of images in the VS database having sufficient similarity to context parameters of the camera 135 can be based on a weighted comparison of metadata. More particularly, weights can be assigned to respective ones of the context parameters of the camera 135 according to various criteria. For instance, context parameters determined to have a larger or more regular effect on the appearance of images captured by the camera 135, such as time of day or lighting conditions, can be given higher weights while context parameters determined to have a smaller or less regular effect can be given lower weights. Next, sets of reference images associated with respective VSs of the VS database 210, as well as the context parameters of these images, are identified. For each of the VSs, an image is then selected from the associated set of reference images based on a comparison between the context parameters of the images and those of the camera. This comparison is weighted using the weights assigned to the context parameters of the camera, as described above.

For each retail brand or other venue classification corresponding to a given VS, multiple references images are stored for the VS in the VS database 210. These reference images are ranked based on their relevance to the current context, as indicated by the context parameters of the camera 135 or other criteria. To identify an image in the VS database 210 corresponding to a target POI, the reference images for various VSs are examined in order according to their rank. The selection process is stopped upon determining that an image sufficiently matches the target POI and camera context, e.g., with at least a threshold degree of confidence. Therefore, by maintaining accurate rankings, the number of images that are examined in response to a given target POI decreases and robustness of the system increases. Here, an image determined to be the most context relevant for a given VS and context (e.g., based on time, season, camera model, image resolution, rough location as determined by a SPS receiver or the like, etc.) is ranked highest, with the remaining images given lower rank. Relevance as utilized for this ranking may be computed based on available contextual information with different weighting functions. Further, if the highest-ranked reference image is consistently not selected and a lower-ranked image is selected with high confidence, the rankings can be modified based on these selections. Here, a score is maintained for each reference image that indicates the number of times the reference image has been matched to a target POI. This score is maintained as part of the metadata for the image and is utilized to dynamically re-rank the most relevant reference images as discussed above.

Here, the POI detection module 230, the database query module 232 and the query processing module 234 are implemented as software components, e.g., by the general purpose processor 111 of the mobile device 12 executing software 170 comprising processor-readable instructions stored on the memory 140. Alternatively, these modules 230, 232 could be implemented in hardware or a combination of hardware and software.

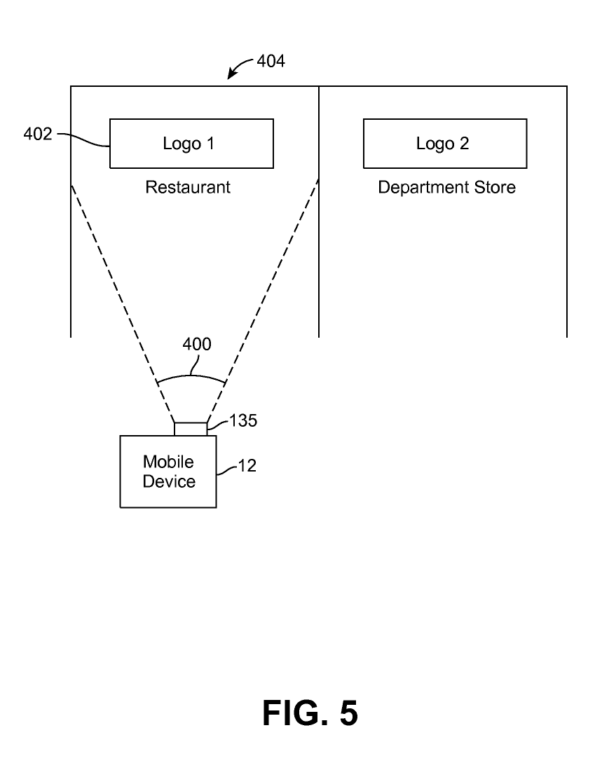

FIG. 5 further illustrates the operation of the camera 135 in the context of the system 220 shown by FIG. 4. A mobile device 12 contains the camera 135 and is configured to monitor real-time imagery of an area corresponding to a field of view 400 of the camera. As the mobile device 12 and/or the camera 135 is moved, the POI detection module 230 monitors for POIs 402, such as a storefront logo associated with a store location 404, within an area defined by the field of view 400 of the camera. Image features corresponding to the identified POI 402, along with context information relating to the mobile device 12 and/or the camera 135, are submitted to the VS database 210 by the database query module 232. Based on information received from the VS database 210, a VS that represents the identified POI 402 is selected. The selected VS is subsequently matched to the store location 404 for determining the location of the mobile device 12 and/or for other uses.

As POIs are detected in view of the camera 135, the detected POIs may also be used as a reference to modify the VS database 210. For instance, as a first POI is detected, other POIs within range of the first POI that may be visible at the location of the camera 135 and that may be useful in refining the location of the mobile device 12 can be determined. In the event that these determined POIs correspond to a subset of the VSs in the VS database 210, the VS database 210 can be modified to reflect the change. For the case of a local VS database 210 implemented at the mobile device 12, these modifications can be carried out by pruning or rebuilding the VS database 210, requesting an updated VS database 210 from the VS server 22, etc.

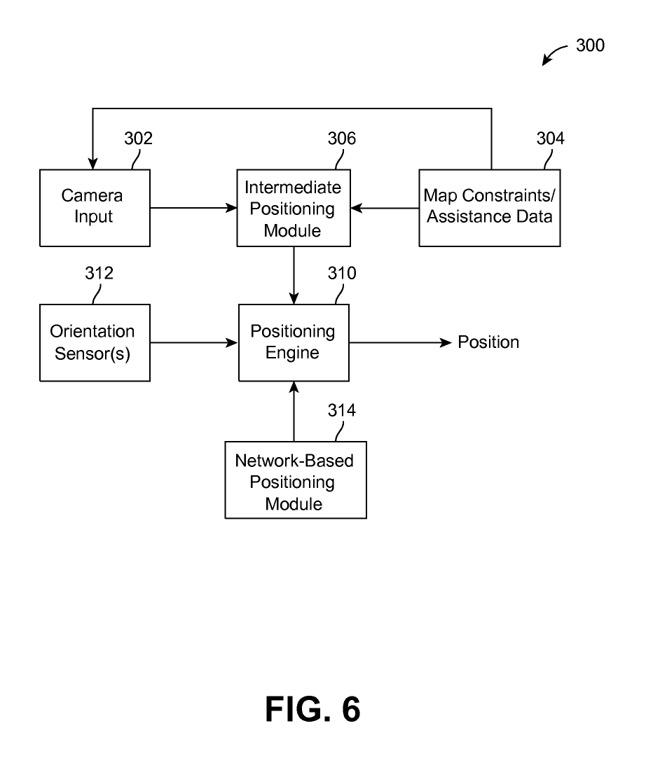

FIG. 6 illustrates a positioning system 300 that can utilize VS generation and analysis as described above. The system 300 operates by visually searching known objects and matching them to POIs on a map, from which a user's location can be determined. For instance, the system 300 can estimate a user's position within a shopping mall by visually searching logos for different retailers, matching the logos to locations within the shopping mall, and determining the user's position based on the determined locations.

Initially, a VS database 210 is built as described above. Here, the VS database 210 is generalized to include all known VSs (e.g., all retailers within shopping malls supported by the system 300, etc.), and each LCI (e.g., shopping mall, etc.) contains POIs corresponding to a subset of the known VSs. Thus, for a given LCI, the VSs for the POIs within the venue are extracted, and a Visual Assistance Database (VAD or VDB) is created for the venue. This database, along with information relating to a map of the LCI, is maintained in the system as assistance data 304.

To utilize the system 300, a user activates a camera associated with a device to be located and pans the camera around its surroundings. The resulting camera input 302 is passed to an intermediate positioning module 306, which identifies store logos and/or other objects from the camera view and compares these objects to POIs based on the assistance data 304. Object identification can be performed based on image feature extraction and matching and/or any other technique(s). In the event that problems are encountered in matching objects, the user can be given feedback for re-obtaining camera input 302, such as slowing down the panning, panning a larger radius, etc.

The intermediate positioning module matches detected POIs to their locations according to the assistance data 304. Based on these locations and the associated camera angles and map constraints associated with the assistance data 304, an intermediate location of the device is estimated based on vision-based positioning techniques such as e.g., pose estimation or the like. For instance, the user location can be estimated based on the possible region from which a detected POI is visible, based on the map constraints and the known location of the POI. Other techniques are also possible. This intermediate location is provided to a positioning engine 310, which combines the intermediate location with other position location data, such as measurements obtained from one or more orientation sensors 312 (e.g., an accelerometer, gyroscope, compass, etc.), network measurements (e.g., received signal strength indication (RSSI), round trip time (RTT), etc.) obtained from a Wi-Fi network or other wireless communication network via a network-based positioning module 314, or the like. Distance between the camera and respective detected POIs may also be calculated or estimated based on, e.g., the size of the POI within the camera imagery, a zoom factor of the camera, orientation of the camera, known size of the POI, etc., and further provided to the positioning engine 310. The positioning engine 310 utilizes the combined position location data to obtain a final position estimate for the device. While the positioning engine 310 is shown as obtaining information from the intermediate positioning module 306, the orientation sensor(s) 312 and the network-based positioning module 314, the positioning engine 310 may obtain data from less than all of these sources, and/or the positioning module 310 may obtain data from other sources not illustrated.

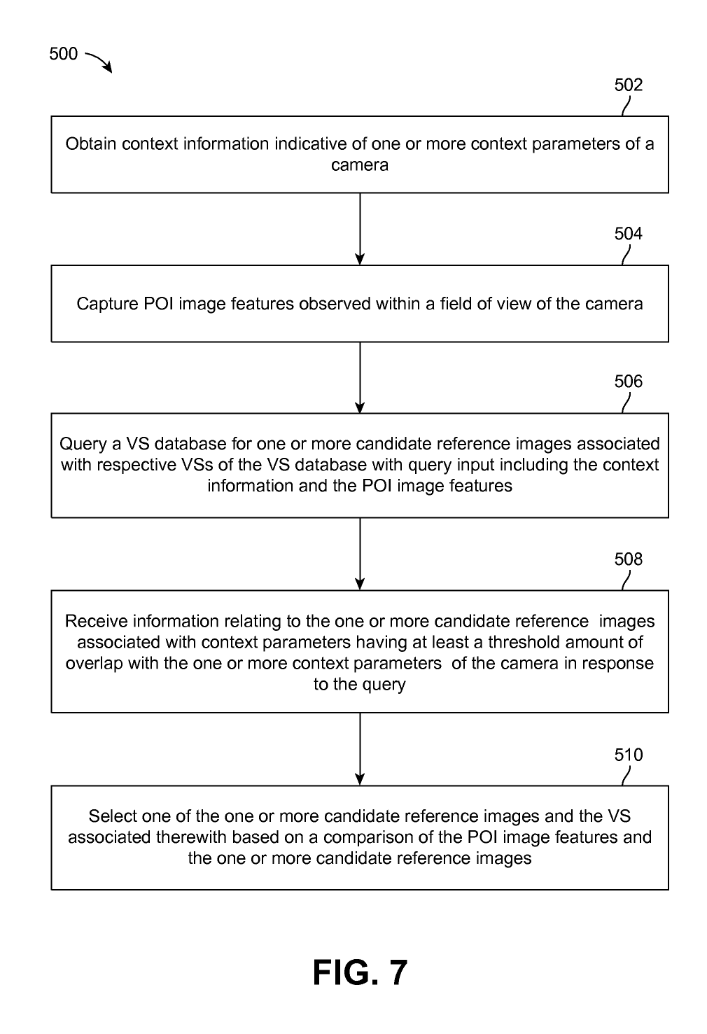

Referring to FIG. 7, with further reference to FIGS. 1-6, a process 500 of visual signature recognition includes the stages shown. The process 500 is, however, an example only and not limiting. The process 500 can be altered, e.g., by having stages added, removed, rearranged, combined, and/or performed concurrently. Still other alterations to the process 500 as shown and described are possible.

At stage 502, context information relating to one or more context parameters of the camera 135 are identified. The camera 135 is associated with a device, e.g., a mobile device 12 that executes a positioning application, and/or a standalone device. The context parameters are identified using a context detection module 202, which can be implemented in software (e.g., via the general-purpose processor 111 executing processor-readable instructions stored on the non-transitory memory 140) and/or hardware.

At stage 504, a POI image is captured from within a field of view 400 of the camera 135, e.g., by the POI detection module 230 implemented in software, hardware or a combination of software and hardware. While a POI image is captured at stage 504 such that image features from the POI image can be extracted and utilized for further operations, the POI image need not be saved or otherwise preserved once the image features corresponding to the POI are extracted. For instance, as provided above, a user may pan the camera 135 around an area of interest, during which images can be captured continually or periodically. POI images can then be detected from these captured images and utilized for further processing, and all other images can be discarded.

At stage 506, a VS database 210 is queried for one or more candidate reference images associated with respective VSs of the VS database 210. The query includes as input the context information obtained at stage 502 and the POI image captured at stage 504. The query is performed, e.g., by the database query module 232 implemented in software and/or hardware. The VS database 210 can be implemented as a network-based service and/or locally implemented at a device that performs the process 500. A combination of these approaches can also be utilized, e.g., a device can locally cache a subset of the VS database 210, such as a group of frequently requested VSs, while the complete VS database 210 is maintained at a remote location.

At stage 508, information relating to the one or more candidate reference images is received in response to the query performed at stage 506. The candidate reference images are associated with context parameters having at least a threshold amount of similarity with the one or more context parameters of the camera in response to the query. Here, a “threshold degree of similarity” is defined in terms of the relationships between context information and the appearance of an object as described above, and refers to context parameters that affect the appearance and image features of an object with sufficient similarity to enable the database query module 232, the database manager module 212 and/or the VS database 210 to match image features of the object with at least a threshold degree of accuracy. Similar to stage 506, the response to the query is received, e.g., by the database query module 232 implemented in software and/or hardware.

At stage 510, one of the candidate reference images received at stage 508, and the VS associated therewith, is selected based on a comparison of the POI image captured at stage 504 and the one or more candidate reference images. The comparison and VS selection at stage 508 is performed by a device associated with the camera 135 and/or a device that performs the process 500 or an entity associated with the VS database 210.

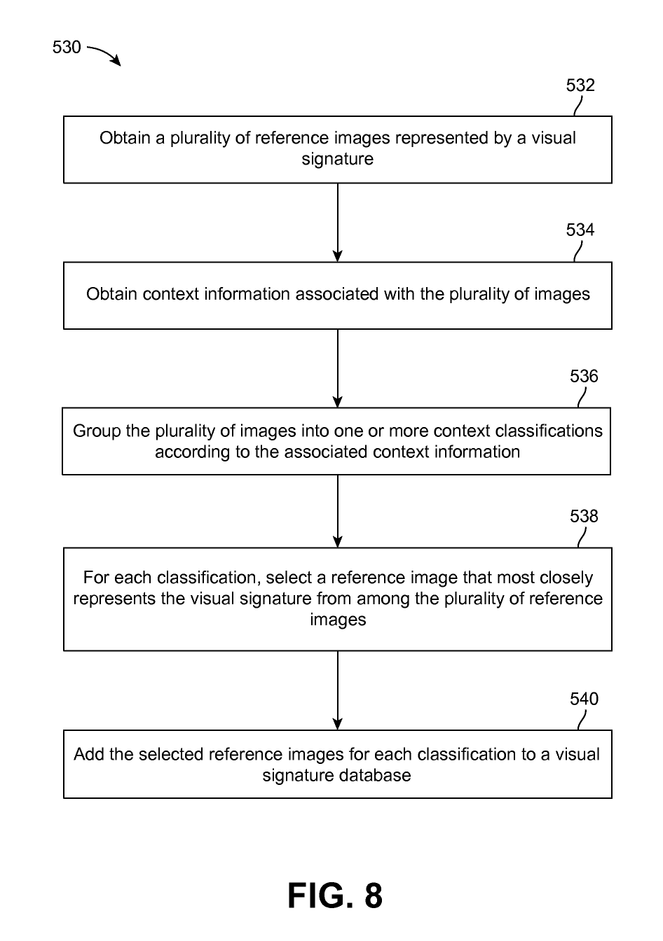

Referring to FIG. 8, with further reference to FIGS. 1-6, a process 530 of populating a visual signature database includes the stages shown. The process 530 is, however, an example only and not limiting. The process 530 can be altered, e.g., by having stages added, removed, rearranged, combined, and/or performed concurrently. Still other alterations to the process 530 as shown and described are possible.

At stage 532, a plurality of reference images represented by a VS are obtained. The reference images can be obtained via a crowdsourcing process in which various users provide information either directly or indirectly (e.g., via image sharing websites, etc.). Alternatively, the images can be provided via other sources, such as an owner of a venue associated with the VS.

At stage 534, context information associated with the plurality of images is obtained. Context parameters corresponding to images are obtained via metadata (e.g., tags, file names, etc.) provided from users from which the images are obtained, metadata associated with the images themselves (e.g., EXIF tag data or other metadata embedded within the images, etc.), date and/or time information obtained from a system clock associated with the camera 135 or the mobile device 12, an approximate location of the camera 135 based on a satellite positioning system, terrestrial positioning system or other positioning means associated with the camera 135 or the mobile device 12, and/or other sources. Additional types of context parameters that may be used include a history of GPS or other satellite readings; model, resolution and/or other properties of the camera 135; sensor readings made at or near the time an image is captured, such as magnetometer orientation readings, barometer readings for floor determination, accelerometer readings for detection of motion blur, temperature and/or humidity measurements indicative of current weather; etc. Other types and/or sources of context parameters could also be used.

According to the context information obtained at stage 534, the obtained reference images are grouped into one or more context classifications at stage 536. Here, the context classifications relate to various context groupings that are determined to impact the appearance of objects representative of a given VS in a substantially similar manner, as described above.

At stage 538, for each classification used at stage 536, a reference image is selected from among the set of reference images that most closely represents the VS. The selection can be performed based on quality criteria (e.g., image resolution, noise level, etc.), comparative matching as described above, and/or other techniques. Subsequently, at stage 540, the reference images selected at stage 538 for each classification are added to a VS database 210.

The stages 532, 534, 536, 538 and 540 of the process 530 can be performed by one or more entities associated with the VS database 210, such as the database manager module 212. The database manager module 212 can be associated with a network computing system, such as a cloud computing service or other network computing service that implements the VS database 210. The database manager module 212 can additionally be implemented in software, hardware or a combination of software and hardware. In addition to the operations of stages 532, 534, 536 and 538, various collected reference images can be processed by the image manager module 214 and/or other entities in the manner described above.

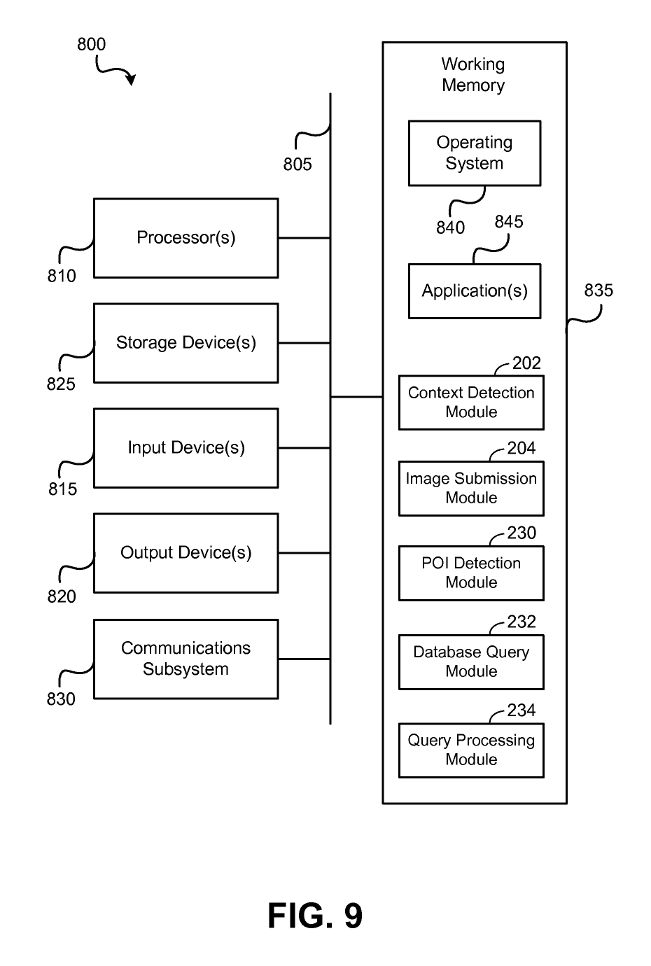

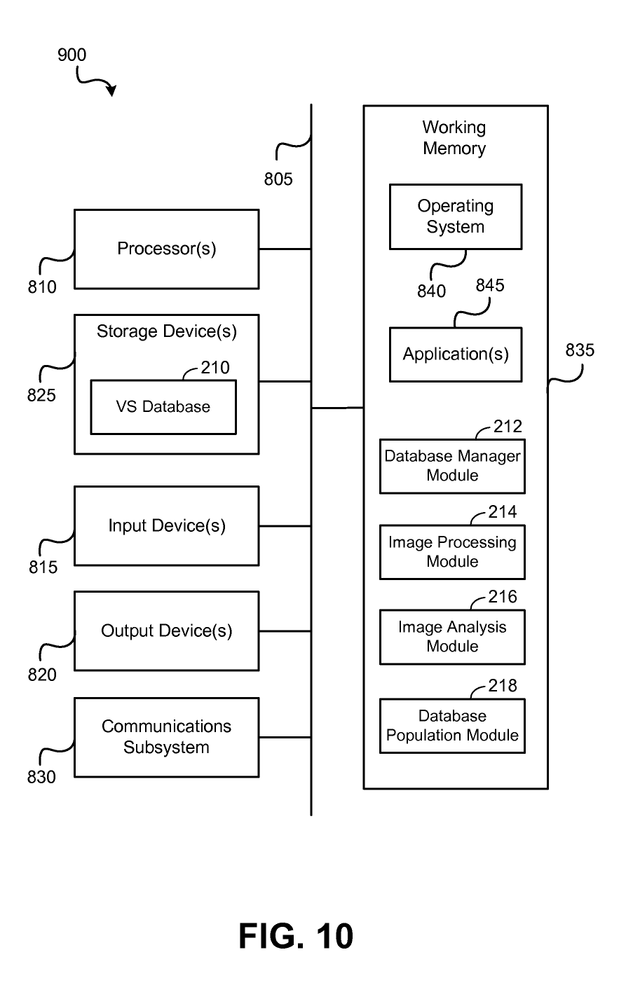

A client computer system 800 as illustrated in FIG. 9 and/or a server computing system 900 as illustrated in FIG. 10 may be utilized to at least partially implement the functionality of the previously described computerized devices. FIGS. 9 and 10 provide schematic illustrations of computer systems 800, 900 that can perform the methods provided by various other embodiments, as described herein, and/or can function as a mobile device or other computer system. FIGS. 9 and 10 provide a generalized illustration of various components, any or all of which may be utilized as appropriate. FIGS. 9 and 10, therefore, broadly illustrate how individual system elements may be implemented in a relatively separated or relatively more integrated manner.

Referring first to the client computer system 800 in FIG. 9, the computer system 800 is shown comprising hardware elements that can be electrically coupled via a bus 805 (or may otherwise be in communication, as appropriate). The hardware elements may include one or more processors 810, including without limitation one or more general-purpose processors and/or one or more special-purpose processors (such as digital signal processing chips, graphics acceleration processors, and/or the like); one or more input devices 815, which can include without limitation a mouse, a keyboard and/or the like; and one or more output devices 820, which can include without limitation a display device, a printer and/or the like. The processor(s) 810 can include, for example, intelligent hardware devices, e.g., a central processing unit (CPU) such as those made by Intel® Corporation or AMD®, a microcontroller, an ASIC, etc. Other processor types could also be utilized.

The computer system 800 may further include (and/or be in communication with) one or more non-transitory storage devices 825, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 800 might also include a communications subsystem 830, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 830 may permit data to be exchanged with a network (such as the network described below, to name one example), other computer systems, and/or any other devices described herein. In many embodiments, the computer system 800 will further comprise, as here, a working memory 835, which can include a RAM or ROM device, as described above.

The computer system 800 also can comprise software elements, shown as being currently located within the working memory 835, including an operating system 840, device drivers, executable libraries, and/or other code, such as one or more application programs 845, which may comprise computer programs provided by various embodiments, and/or may be designed to implement methods, and/or configure systems, provided by other embodiments, as described herein. By way of example, the context detection module 202, image submission module 204, POI detection module 230, database query module 232 and/or query processing module 234 as described above may be at least partially implemented as software components of the computer system 800 loaded in the working memory 835 and executed by the processor(s) 810. One or more other processes described herein might also be implemented as code and/or instructions executable by a computer (and/or a processor within a computer). Such code and/or instructions can be used to configure and/or adapt a general purpose computer (or other device) to perform one or more operations in accordance with the described methods.

A set of these instructions and/or code might be stored on a computer-readable storage medium, such as the storage device(s) 825 described above. In some cases, the storage medium might be incorporated within a computer system, such as the computer system 800. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

Substantial variations may be made in accordance with specific desires. For example, customized hardware might also be used, and/or particular elements might be implemented in hardware, software (including portable software, such as applets, etc.), or both. Further, connection to other computing devices such as network input/output devices may be employed.

A computer system (such as the computer system 800) may be used to perform methods in accordance with the disclosure. Some or all of the procedures of such methods may be performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another computer-readable medium, such as one or more of the storage device(s) 825. Merely by way of example, execution of the sequences of instructions contained in the working memory 835 might cause the processor(s) 810 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 800, various computer-readable media might be involved in providing instructions/code to processor(s) 810 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 825. Volatile media include, without limitation, dynamic memory, such as the working memory 835. Transmission media include, without limitation, coaxial cables, copper wire and fiber optics, including the wires that comprise the bus 805, as well as the various components of the communication subsystem 830 (and/or the media by which the communications subsystem 830 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, a Blu-Ray disc, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals and/or the like, are all examples of carrier waves on which instructions can be encoded, in accordance with various embodiments of the invention.

The communications subsystem 830 (and/or components thereof) generally will receive the signals, and the bus 805 then might carry the signals (and/or the data, instructions, etc. carried by the signals) to the working memory 835, from which the processor(s) 805 retrieves and executes the instructions. The instructions received by the working memory 835 may optionally be stored on a storage device 825 either before or after execution by the processor(s) 810.

Referring to the server computer system 900 illustrated in FIG. 10, the server computer system 900 includes components 805, 810, 815, 820, 825, 830, 835 that function similarly to those described above with respect to the client computer system 800. In addition to the functionality of the storage device(s) 825 of the computer system 800, the storage device(s) 825 here also implement the VS database 210 as described above. Further, the working memory 835 of the computer system 900 at least partially implements the above-described functionality of the database manager module 212, the image manager module 214, the image analysis module 216 and the database population module 218 in addition to the operating system 840 and application(s) 845 described with respect to the computer system 800.

The client computer system 800 and the server computer system 900 can be implemented, either wholly or in part, by any suitable entity or combination of entities as described above. Here, the client computer system 800 is implemented by the mobile device 12, and the server computer system 900 is implemented at the VS server in the case of a centralized VS database 210 and/or at the mobile device 12 in the case of a localized VS database 210. Other implementations are also possible.

The methods, systems, and devices discussed above are examples. Various alternative configurations may omit, substitute, or add various procedures or components as appropriate. For instance, in alternative methods, stages may be performed in orders different from the discussion above, and various stages may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for visual signature (VS) recognition at a mobile device, the method comprising:
obtaining context information indicative of one or more context parameters of a camera;
capturing a point of interest (POI) image within a field of view of the camera;
submitting a query to a VS database for one or more candidate reference images associated with respective VSs of the VS database, the query providing as input the context information and the POI image;
receiving information relating to the one or more candidate reference images in response to the query, wherein the one or more candidate reference images are associated with context parameters having at least a threshold amount of similarity with the one or more context parameters of the camera; and
selecting one of the one or more candidate reference images and the VS associated therewith based on a comparison of the POI image and the one or more candidate reference images.

2. The method of claim 1 wherein the one or more context parameters comprise at least one of a time of detecting the POI, a date of detecting the POI, lighting conditions associated with the POI, a geographic area in which the camera is located, an identity of the camera, or settings utilized by the camera.

3. The method of claim 1 wherein the one or more context parameters are obtained from user input.

4. The method of claim 1 wherein the camera is associated with a wireless communication device, and the one or more context parameters are obtained from information stored on the wireless communication device.

5. The method of claim 1 wherein the selecting comprises selecting a candidate reference image from among the one or more candidate reference images that most closely matches the POI image.

6. The method of claim 5 wherein receiving the information relating to the one or more candidate reference images comprises:
assigning weights to respective ones of the one or more context parameters of the camera;
identifying sets of reference images associated with respective ones of a plurality of VSs of the VS database and context parameters for the reference images of the sets of reference images; and
for each of the plurality of VSs, selecting an image from an associated one of the sets of reference images based on a comparison of the context parameters of the reference images and the context parameters of the camera, wherein the comparison is weighted according to the weights.

7. The method of claim 1 further comprising:
obtaining a location of the POI based on location data associated with a selected VS; and
estimating a location of the camera based at least in part on the location of the POI.

8. The method of claim 7 wherein the VS is associated with a retailer and the POI is a retail location operated by the retailer.

9. The method of claim 1 further comprising rebuilding the VS database based on a selected candidate reference image.

10. A method for managing a visual signature (VS) database, the method comprising:
obtaining a plurality of images of objects represented by a VS;
obtaining context information associated with the plurality of images;
grouping the plurality of images into one or more context classifications according to the context information associated with the plurality of images;
for respective ones of the one or more context classifications, selecting an image representative of the VS according to one or more criteria; and
adding selected images for the respective ones of the one or more context classifications to entries of the VS database corresponding to the VS.

11. The method of claim 10 wherein the context information comprises at least one of a time an image is captured, a date an image is captured, a location at which an image is captured, lighting conditions associated with an image, an identity of a camera with which an image is captured, or camera settings associated with an image.

12. The method of claim 10 further comprising modifying at least one of the images prior to the selecting, wherein the modifying comprises at least one of cropping or rotating.

13. The method of claim 10 wherein obtaining the context information comprises extracting metadata embedded within respective ones of the plurality of images.

14. The method of claim 10 wherein obtaining the plurality of images comprises obtaining at least some of the plurality of images from an image sharing service or one or more mobile devices.

15. The method of claim 10 wherein the selecting comprises selecting an image according to image quality metrics.

16. The method of claim 15 wherein the image quality metrics comprise at least one of image resolution or observed level of background noise.

17. The method of claim 10 wherein the selecting comprises, for each of the one or more context classifications, attempting to match images for the context classification with one or more other images for the context classification and selecting an image for the context classification that exhibits at least a threshold amount of similarity to a highest number of the one or more other images for the context classification.

18. The method of claim 10 further comprising:
receiving a query for images associated with the VS database, wherein the query is associated with a point of interest and one or more context parameters; and
selecting a plurality of candidate images from the VS database in response to the query.

19. The method of claim 18 further comprising evaluating estimated relevance of the candidate images according to the one or more context parameters, the point of interest and context parameters of the candidate images.

20. The method of claim 19 further comprising ranking the candidate images according to the estimated relevance.

21. The method of claim 20 further comprising:
performing a determination of whether a highest ranked candidate image matches the one or more context parameters and the point of interest with at least a threshold degree of confidence;
if the determination is positive, selecting the highest ranked candidate image; and
if the determination is negative, repeating the determining for a next highest ranked candidate image.

22. The method of claim 20 further comprising:
selecting one of the candidate images in response to the query; and
adjusting rankings of the candidate images based on the selecting.

23. The method of claim 18 wherein selecting the plurality of images comprises:
assigning weights to respective ones of the one or more context parameters associated with the query;
identifying sets of images associated with respective ones of a plurality of VSs of the VS database and context parameters for the images of the sets of images; and
for each of the plurality of VSs, selecting an image from an associated one of the sets of images based on a comparison of the context parameters associated with the query and the context parameters for the images, wherein the comparison is weighted according to the weights.

24. A visual signature (VS) recognition system comprising:
a camera associated with one or more context parameters and configured to provide imagery within a field of view of the camera;
a point of interest (POI) detection module communicatively coupled to the camera and configured to detect a POI image within the field of view of the camera;
a database query module communicatively coupled to the POI detection module and configured to submit a query to a VS database for one or more candidate reference images associated with respective VSs of the VS database, the query providing as input the one or more context parameters and the POI image; and
a query processing module configured to receive information relating to the one or more candidate reference images in response to the query, wherein the one or more candidate reference images are associated with context parameters having at least a threshold amount of similarity with the one or more context parameters of the camera, and to select one of the one or more candidate reference images and the VS associated therewith based on a comparison of the POI image and the one or more candidate reference images.

25. The system of claim 24 further comprising a context detection module communicatively coupled to the camera and the database query module and configured to obtain information relating to the one or more context parameters.

26. The system of claim 25 wherein the one or more context parameters comprise at least one of a time of detecting the POI, a date of detecting the POI, lighting conditions associated with the POI, a geographic area in which the camera is located, an identity of the camera, or settings utilized by the camera.

27. The system of claim 24 wherein the query processing module is further configured to select a candidate reference image from among the one or more candidate reference images that most closely matches the POI image.

28. The system of claim 24 further comprising a positioning engine communicatively coupled to the query processing module and configured to obtain a location of the POI based on location data associated with a selected VS and to estimate a location of the camera based at least in part on the location of the POI.

29. The system of claim 24 further comprising a wireless communications device, wherein the camera is housed within the wireless communications device.

30. The system of claim 29 wherein the VS database is stored by the wireless communications device.

31. The system of claim 30 further comprising a database manager module communicatively coupled to the query processing module and the VS database and configured to dynamically configure and build the VS database based on a selected candidate reference image.

32. The system of claim 29 wherein the VS database is stored at a VS server remote from the wireless communications device.

33. A visual signature (VS) database management system comprising:
an image analysis module configured to obtain a plurality of images of objects represented by a VS and context information associated with the plurality of images, to group the plurality of images into one or more context classifications according to the context information associated with the plurality of images, and to select images for respective ones of the one or more context classifications that best represent the VS according to one or more criteria; and
a database population module communicatively coupled to the image analysis module and configured to add selected images for the respective ones of the one or more context classifications to a VS database and to classify the selected images as entries of the VS database corresponding to the VS.

34. The system of claim 33 wherein the context information comprises at least one of a time an image is captured, a date an image is captured, a location at which an image is captured, lighting conditions associated with an image, an identity of a camera with which an image is captured, or camera settings associated with an image.

35. The system of claim 33 further comprising an image manager module communicatively coupled to the image analysis module and configured to modify at least one of the images prior to selection by the database population module.

36. The system of claim 33 wherein the image analysis module is further configured to obtain at least some of the plurality of images from an image sharing service or one or more mobile devices.

37. The system of claim 33 wherein the image analysis module is further configured to select an image for respective context classifications according to image quality metrics.

38. The system of claim 33 wherein the image analysis module is further configured to select an image for respective ones of the one or more context classifications by attempting to match images for a context classification with one or more other images for the context classification and selecting an image for the context classification that exhibits at least a threshold amount of similarity to a highest number of the one or more other images for the context classification.

39. The system of claim 33 wherein the image analysis module is further configured to receive a query for images associated with the VS database, wherein the query is associated with a point of interest and one or more context parameters, and to select a plurality of candidate images from the VS database in response to the query.

40. The system of claim 39 wherein the image analysis module is further configured to evaluate estimated relevance of the candidate images according to the one or more context parameters, the point of interest and context parameters of the candidate images and to rank the candidate images according to the estimated relevance.

41. The system of claim 40 wherein the image analysis module is further configured to determine whether a highest ranked candidate image matches the one or more context parameters and the point of interest with at least a threshold degree of confidence, to select the highest ranked candidate image upon a positive determination, and to repeat the determining for a next highest ranked candidate image upon a negative determination.

42. The system of claim 40 wherein the image analysis module is further configured to select one of the candidate images in response to the query and to adjust rankings of the plurality of images based on the selecting.

43. The system of claim 39 wherein the image analysis module is further configured to assign weights to respective ones of the one or more context parameters associated with the query, to identify sets of images associated with respective ones of a plurality of VSs of the VS database and context parameters for the images of the sets of images, and to select an image for each of the plurality of VSs from an associated one of the sets of images based on a comparison of the context parameters associated with the query and the context parameters for the images, wherein the comparison is weighted according to the weights.

44. A system for visual signature (VS) recognition, the system comprising:
a camera associated with one or more context parameters and configured to provide imagery within a field of view of the camera;
point of interest (POI) detection means, communicatively coupled to the camera, for detecting a POI image within the field of view of the camera;
query means, commutatively coupled to the POI detection means, for submitting a query to a VS database for one or more candidate reference images associated with respective VSs of the VS database, the query providing as input the one or more context parameters and the POI image; and
selection means, communicatively coupled to the query means, for receiving information relating to the one or more candidate reference images in response to the query, wherein the one or more candidate reference images are associated with context parameters having at least a threshold amount of overlap with the one or more context parameters of the camera, and selecting one of the one or more candidate reference images and the VS associated therewith based on a comparison of the POI image and the one or more candidate reference images.

45. The system of claim 44 further comprising context means, communicatively coupled to the camera and the query means, for obtaining information relating to the one or more context parameters.

46. The system of claim 45 wherein the one or more context parameters comprise at least one of a time of detecting the POI, a date of detecting the POI, lighting conditions associated with the POI, a geographic area in which the camera is located, an identity of the camera, or settings utilized by the camera.

47. The system of claim 44 wherein the selection means comprises means for selecting a candidate reference image from among the one or more candidate reference images that most closely matches the POI image.

48. The system of claim 44 further comprising positioning means, communicatively coupled to the selection means, for obtaining a location of the POI based on location data associated with a selected VS and estimating a location of the camera based at least in part on the location of the POI.

49. The system of claim 44 further comprising database manager means, communicatively coupled to the selection means and the VS database, for dynamically configuring and building the VS database based on a selected candidate reference image.

50. A system for visual signature (VS) database management, the system comprising:
collection means for obtaining a plurality of images of objects represented by a VS and context information associated with the plurality of images;
classification means, communicatively coupled to the collection means, for grouping the plurality of images into one or more context classifications according to the context information associated with the plurality of images;
selection means, communicatively coupled to the collection means and the classification means, for selecting images for respective ones of the one or more context classifications that best represent the VS according to one or more criteria; and
database population means, communicatively coupled to the selection means, for storing images selected by the selection means for the respective ones of the context classifications as entries of a VS database corresponding to the VS.

51. The system of claim 50 wherein the context information comprises at least one of a time an image is captured, a date an image is captured, a location at which an image is captured, lighting conditions associated with an image, an identity of a camera with which an image is captured, or camera settings associated with an image.

52. The system of claim 50 further comprising image management means, communicatively coupled to the collection means, for modifying at least one of the images obtained by the collection means.

53. The system of claim 50 wherein the collection means comprises means for obtaining at least some of the plurality of images from an image sharing service or one or more mobile devices.

54. The system of claim 50 wherein the selection means comprises means for selecting an image for respective ones of the one or more context classifications according to image quality metrics.

55. The system of claim 50 wherein the selection means comprises:
means for attempting to match images for a context classification with one or more other images for the context classification; and
means for selecting an image for the context classification that exhibits at least a threshold amount of similarity to a highest number of the one or more other images for the context classification.

56. The system of claim 50 further comprising query processing means, communicatively coupled to the database population means, for receiving a query for images associated with the VS database, wherein the query is associated with a point of interest and one or more context parameters, and selecting a plurality of candidate images from the VS database in response to the query.

57. The system of claim 56 wherein the query processing means comprises:
means for evaluating estimated relevance of the candidate images according to the one or more context parameters, the point of interest and context parameters of the candidate images; and
means for ranking the candidate images according to the estimated relevance.

58. The system of claim 57 wherein the query processing means comprises:
means for determining whether a highest ranked candidate image matches the one or more context parameters and the point of interest with at least a threshold degree of confidence;
means for selecting the highest ranked candidate image upon a positive determination; and
means for repeating the determining for a next highest ranked candidate image upon a negative determination.

59. The system of claim 57 wherein the query processing means comprises:
means for selecting one of the candidate images in response to the query; and
means for adjusting rankings of the candidate images based on the selecting.

60. The system of claim 56 wherein the query processing means comprises:
means for assigning weights to respective ones of the one or more context parameters associated with the query;
means for identifying sets of images associated with respective ones of a plurality of VSs of the VS database and context parameters for the images of the sets of images; and
means for selecting an image for each of the plurality of VSs from an associated one of the sets of images based on a comparison of the context parameters associated with the query and the context parameters for the images, wherein the comparison is weighted according to the weights.

61. A computer program product residing on a processor-executable computer storage medium, the computer program product comprising processor-executable instructions configured to cause a processor to:
identify context information indicative of one or more context parameters of a camera;
capture point of interest (POI) image features within a field of view of the camera;
submit a query to a VS database for one or more candidate reference images associated with respective VSs of the VS database, the query providing as input the context information and the POI image features;
receive information relating to the one or more candidate reference images in response to the query, wherein the one or more candidate reference images are associated with context parameters having at least a threshold amount of overlap with the one or more context parameters of the camera; and
select one of the one or more candidate reference images and the VS associated therewith based on a comparison of the POI image features and the one or more candidate reference images.

62. The computer program product of claim 61 further comprising processor-executable instructions configured to cause the processor to obtain information relating to the one or more context parameters.

63. The computer program product of claim 61 wherein the context parameters comprise at least one of a time of detecting the POI, a date of detecting the POI, lighting conditions associated with the POI, a geographic area in which the camera is located, an identity of the camera, or settings utilized by the camera.

64. The computer program product of claim 61 wherein the instructions configured to cause the processor to select one of the one or more candidate reference images comprises instructions configured to cause the processor to select a candidate reference image that most closely matches the POI image features.

65. The computer program product of claim 61 further comprising processor-executable instructions configured to cause the processor to:
obtain a location of the POI based on location data associated with a selected VS; and
estimate a location of the camera based at least in part on the location of the POI.

66. The computer program product of claim 61 further comprising processor-executable instructions configured to cause the processor to rebuild the VS database based on a selected candidate reference image.

67. A computer program product residing on a processor-executable computer storage medium, the computer program product comprising processor-executable instructions configured to cause a processor to:
obtain a plurality of images of objects represented by a VS and context information associated with the plurality of images;
group the plurality of images into one or more context classifications according to the context information associated with the plurality of images;
select images for respective ones of the one or more context classifications that best represent the VS according to one or more criteria; and
store images selected for the respective ones of the one or more context classifications as entries of a VS database corresponding to the VS.

68. The computer program product of claim 67 wherein the context information comprises at least one of a time an image is captured, a date an image is captured, a location at which an image is captured, lighting conditions associated with an image, an identity of a camera with which an image is captured, or camera settings associated with an image.

69. The computer program product of claim 67 further comprising processor-executable instructions configured to cause the processor to modify at least one of the plurality of images.

70. The computer program product of claim 67 wherein the instructions configured to cause the processor to obtain the plurality of images are further configured to cause the processor to obtain at least some of the plurality of images from an image sharing service or one or more mobile devices.

71. The computer program product of claim 67 wherein the instructions configured to cause the processor to select images for the respective ones of the one or more context classifications are further configured to cause the processor to select an image for respective context classifications according to image quality metrics.

72. The computer program product of claim 67 wherein the instructions configured to cause the processor to select images for the respective ones of the one or more context classifications are further configured to cause the processor to:
attempt to match images for a context classification with one or more other images for the context classification; and
select an image for the context classification that exhibits at least a threshold amount of similarity to a highest number of the one or more other images for the context classification.

73. The computer program product of claim 67 further comprising processor-executable instructions configured to cause the processor to:
receive a query for images associated with the VS database, wherein the query is associated with a point of interest and one or more context parameters; and
select a plurality of candidate images from the VS database in response to the query.

74. The computer program product of claim 73 further comprising processor-executable instructions configured to cause the processor to:
evaluate estimated relevance of the candidate images according to the one or more context parameters, the point of interest and context parameters of the candidate images; and
rank the plurality of candidate images according to the estimated relevance.

75. The computer program product of claim 74 further comprising processor-executable instructions configured to cause the processor to:
determine whether a highest ranked candidate image matches the one or more context parameters and the point of interest with at least a threshold degree of confidence;
select the highest ranked candidate image upon a positive determination; and
repeat the determining for a next highest ranked candidate image upon a negative determination.

76. The computer program product of claim 74 further comprising processor-executable instructions configured to cause the processor to:
select one of the candidate images in response to the query; and
adjust rankings of the candidate images based on the selecting.

77. The computer program product of claim 73 wherein the instructions configured to cause the processor to select the plurality of images are further configured to cause the processor to:
assign weights to respective ones of the one or more context parameters associated with the query;
identify sets of images associated with respective ones of a plurality of VSs of the VS database and context parameters for the images of the sets of images; and
select, for each of the plurality of VSs, an image from an associated one of the sets of images based on a comparison of the context parameters associated with the query and the context parameters for the images, wherein the comparison is weighted according to the weights.
